(19) United States
(12) Patent Application Publication
(10) Pub. No.: US 2005/0064900 A1
(43) Pub. Date: Mar. 24, 2005

(54) System and method for using a mobile telephone to retrieve information about an article

(75) Inventors: Norman Goris, Dortmund (DE); Wolfgang Scheit, Lochhofen/Sauerlach (DE)

Correspondence Address: HITT GAINES, PC;AGERE SYSTEMS INC., PO BOX 832570, RICHARDSON, TX, 75083, US

(73) Assignee: Agere Systems, Incorporated, Allentown, PA (US)

(21) Appl. No.: 10/669,848

(22) Filed: Sep. 24, 2003

(51) Int. Cl. H04M 1/00

(52) U.S. Cl. 455/556.1; 455/550.1

(57) ABSTRACT

A system for, and method of, using a mobile telephone to retrieve information about an article and an associated mobile telephone. In one embodiment, the system includes: (1) a camera, associated with the mobile telephone, that records an image of coded data associated with the article and (2) a database, remote from the mobile telephone, that supplies information about the article to the mobile telephone based on a received, decoded form of the coded data derived from the image.

### TECHNICAL FIELD OF THE INVENTION

The present invention is directed, in general, to wireless telecommunication and, more specifically, to a system and method for using a mobile telephone to retrieve information about an article.

### BACKGROUND OF THE INVENTION

Almost every article that can be bought in a store or a warehouse is nowadays provided with coded data attached to it. The most commonly used code in this respect is a barcode, which usually takes the form of a one-dimensional barcode, though two-dimensional barcodes are also used increasingly.

The checkout stand of a store usually is provided with a barcode reader connected to a computer having access to a database holding information on each article sold in the store and especially holding price information associated with each article. The same database often also holds inventory information on how many pieces of each article are currently in stock.

Especially in stores with a large assortment of articles, a customer often gets in a situation in which he wants to know the price of an article that has no readable price on or next to it and therefore needs to read the coded data, especially the pricing information. For this purpose some stores provide “public” barcode or similar readers. This, however, involves additional costs to the store.

Another situation in which it would be useful for the customer to be able to read the coded data is in a store that accepts all kinds of different currencies, for instance located at an international airport, in order to get the pricing information for an article in his own currency.

Furthermore, it is necessary for store employees, including those remote from the checkout stand, to be able to read the coded data and relate this data to the price of an article.

A possibility for reading barcode-based data is to use a barcode reader equipment that can be connected to a mobile phone, enabling the user to send the data to a certain server based service with a database for receiving back the pricing information at the mobile phone. However, one problem with this arrangement is that, in addition to a mobile phone, additional equipment (e.g., a barcode reader) is needed, which reduces the ease of use and increases the costs. Additionally the performance is restricted due to the limited bit-rates GSM communication networks still offer.

Accordingly, what is needed in the art is a way to retrieve information regarding an article based on coded data gathered from the article, particularly in an easy, low cost and fast manner.

### SUMMARY OF THE INVENTION

To address the above-discussed deficiencies of the prior art, the present invention provides, in one aspect, a system for using a mobile telephone to retrieve information about an article and an associated mobile telephone. The system includes: (1) a camera, associated with the mobile telephone, that records an image of coded data associated with the article and (2) a database, remote from the mobile telephone, that supplies information about the article to the mobile telephone based on a received, decoded form of the coded data derived from the image.

In another aspect, the present invention provides a method of using a mobile telephone to retrieve information about an article. The method includes: (1) recording, with a camera associated with the mobile telephone, an image of coded data associated with the article and (2) supplying, from a database remote from the mobile telephone, information about the article to the mobile telephone based on a received, decoded form of the coded data derived from the image.

In yet another aspect, the present invention provides a mobile telephone. The mobile telephone includes: (1) a camera, (2) software that receives an image associated with an article from the camera, decodes coded data contained in the image and queues the data for transmission to a database remote from the mobile telephone and (3) a display that receives and displays information about the article from the database.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of one embodiment of a system for using a mobile telephone to retrieve information about an article constructed according to the principles of the present invention;

FIG. 2 illustrates a flow diagram of one embodiment of a method of using a mobile telephone to retrieve information about an article carried out according to the principles of the present invention; and

FIG. 3 illustrates a flow diagram of another embodiment of a method of using a mobile telephone to retrieve information about an article carried out according to the principles of the present invention.

### DETAILED DESCRIPTION

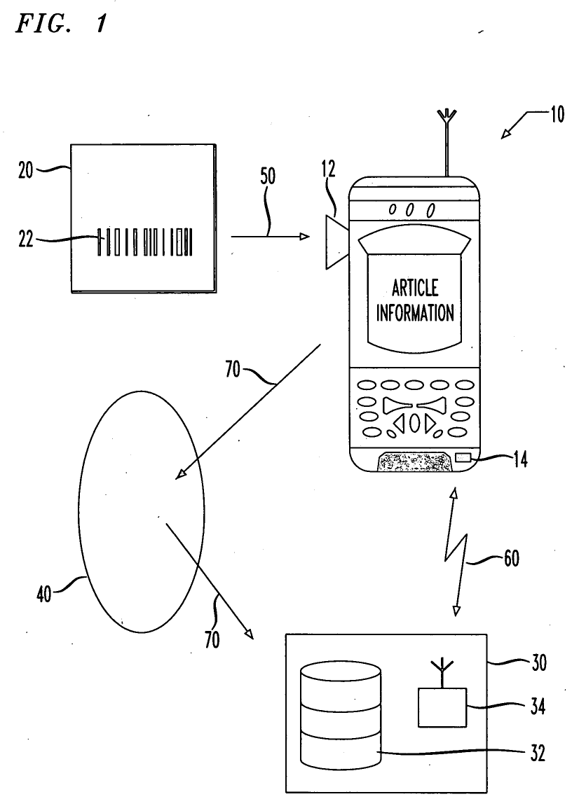

Referring initially to FIG. 1, illustrated is a schematic diagram of an embodiment of a system for using a mobile telephone to retrieve information about an article constructed according to the principles of the present invention.

A mobile telephone 10 is depicted having a photo camera 12 mounted to the mobile telephone 10. An article 20 is marked with an attached barcode 22. The barcode 22 includes coded data about the article 20, such as the number system that the barcode 22 uses, a manufacturer code, a product code and check codes.

If the user of the mobile telephone 10 wants to interpret the coded data 22 of the article 20 and get access to further information related to the article 20, first a database within the mobile telephone 10 is synchronized with a corresponding database 32 located in a server 30. The database 32 holds a plurality of different code and/or article information.

In the illustrated embodiment, the synchronization is performed by means of a direct radio link 60. For this purpose, the mobile telephone lo is provided with a wireless interface 14 adapted to operate according to, for example, Bluetooth standards. Accordingly, the server 30 comprises a corresponding interface 34. It should be clear to one skilled in the art that the synchronization can be optimized in that only changes in the database 32 made since the last synchronization need to be transferred, thereby considerably reducing the time needed for the synchronization process.

After synchronizing the databases, a picture 50 of the barcode 22 is recorded by use of the camera 12 of the mobile telephone 10. The record of the barcode 22 then is analyzed by means of barcode reader functionality in the mobile telephone 10 or associated with the server 30. The analyzed data is then compared with the information in the database 32 and by that additional information related to the article 20 is found. This information can then be displayed in the display of the mobile telephone 10.

It should be clear that the steps following activation by the user are performed automatically by means of an application run on the mobile telephone. The application can provide additional functionality such as, for instance, a pre-selection of the information of the database entry related to the article 20 which is to be displayed.

The decoded data of a single or a plurality of articles can also be stored in a memory of the mobile telephone 10 for later reference.

In particular, whenever data of identical articles is decoded, this can also be counted. Thus information about stock numbers can be gathered. For further processing, this stock information can be transmitted via a GSM communication network 40 back to the server, in this example in the form of an attachment to an e-mail message 70.

Two exemplary methods of operating the system of FIG. 1 will now be described.

Checking the price in a selected currency

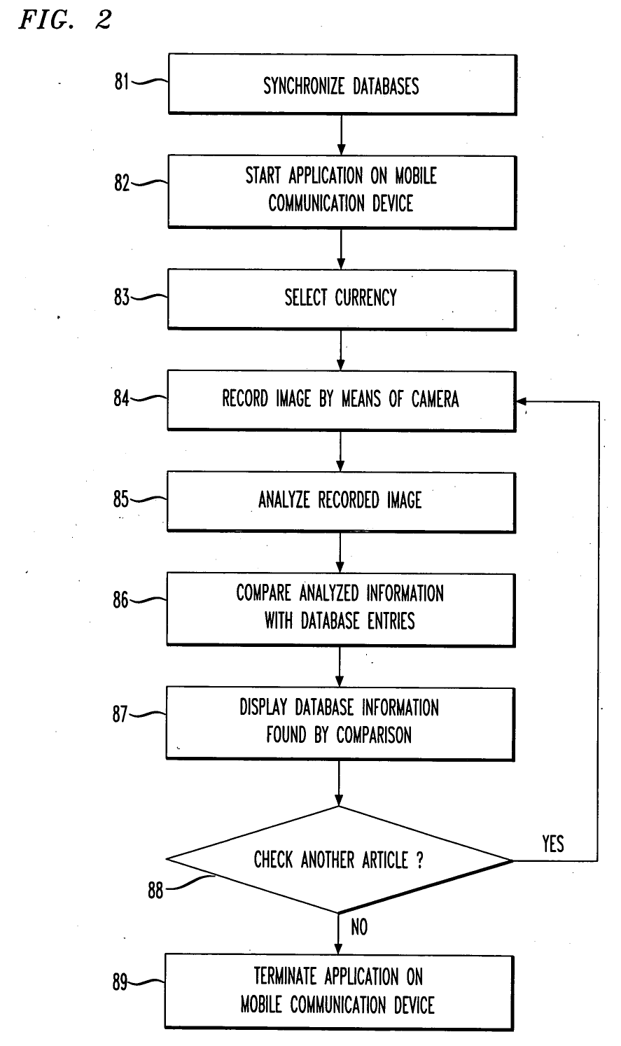

Turning now to FIG. 2, illustrated is a flow diagram of one embodiment of a method of using a mobile telephone to retrieve information about an article carried out according to the principles of the present invention. The purpose in this example is to get the price of an article with an attached barcode in a selected currency. This need arises for instance for a customer in a store located in an international airport, the store accepting a plurality of currencies.

For this purpose, the customer uses his mobile telephone having a photo camera and a wireless, e.g. Bluetooth, interface.

The customer first moves into the range of an accordingly marked “hot spot” and establishes a connection between his mobile telephone and a server according to Bluetooth standards. If the customer does not already have the appropriate application stored on his mobile telephone, it is transferred via Bluetooth from the server, along with any necessary database structure. Then the database on the mobile telephone is synchronized in a step 81 with a corresponding database on the server, the server database holding price information in a plurality of currencies related to the data encoded in the barcode for all articles in the store.

After synchronization is finished, the customer is notified by a message on the mobile telephone display and can now start the application on the mobile telephone in a step 82. The application comprises a pre-selection functionality with regard to the currency that is to be displayed. So after starting the application the customer first selects a currency from a list in a step 83.

After choosing an article of interest, the customer records an image in a step 84 of the attached barcode 22 by means of the camera of his mobile telephone.

The recorded image is then analyzed in a step 85, and the analyzed data is compared with the available database entries in a step 86. When the matching database entry is found, the price information in the pre-selected currency is displayed in a step 87 on the display of the mobile telephone.

If the customer wants to check another article, the steps 84 to 87 are repeated in a decisional step 88, otherwise the application on the mobile telephone is terminated in a step 89.

Checking stock numbers

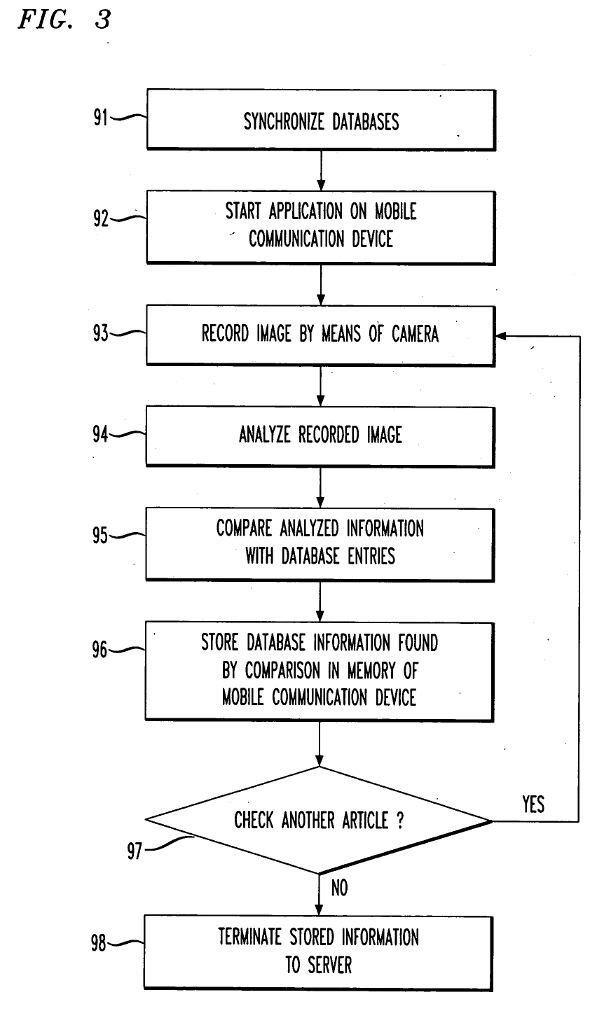

Turning now to FIG. 3, illustrated is a flow diagram of another embodiment of a method of using a mobile telephone to retrieve information about an article carried out according to the principles of the present invention. The purpose in this example is to check the stock numbers of articles.

For this purpose, a store employee is equipped with a mobile telephone having a photo camera and a wireless, e.g. Bluetooth, interface.

According to the above described embodiment of the method, a database within the mobile telephone is synchronized in a step 91 with a database located on a server.

Then the employee starts, in a step 92, an appropriate application stored on the mobile telephone and records the image, in a step 93, of a barcode attached to a first article. This record is analyzed in a step 94 and compared in a step 95 with the database entries. In this example, from the database entry which is found to match the analyzed information an article ID is extracted and stored, in a step 96, in the memory of the mobile telephone 10. The article ID can for example be a consecutive number internally used by the store.

The steps 93 to 96 are then repeated in a decisional step 97 for a plurality of articles, preferably for the complete stock of at least one article. To save memory of the mobile telephone, whenever an article ID is encountered that is already stored, it is not stored again, but instead a corresponding counter is raised by one.

After storing the article IDs of a plurality of articles in this way, this stored information is transmitted in a step 98 as an e-mail attachment back to the server via a GSM communication network.

Although the invention is described with regard to specific embodiments, the invention is covering several modified embodiments, without leaving the scope of protection as defined by the appended set of claims.

For example, the internal or externally connectable camera of the mobile communication device may be additionally or alternatively designed as being a video camera, so that the record is at least a part of a video sequence. Instead of the described mobile telephone, an other mobile communication device may be used by the invention, for example a personal digital assistant (PDA) or a mobile digital assistant (MDA). Instead of using Bluetooth for synchronization, WLAN or HomeRF/SWAP standards could be used, though interfaces supporting such standards are not yet common in mobile devices. Also an infrared connection can be used for synchronization.

Further, instead of providing the user visually by means of the display with the ascertained information related to the article, this could also be achieved acoustically for example by means of an integrated loudspeaker.

Although the present invention has been described in detail, those skilled in the art should understand that they can make various changes, substitutions and alterations herein without departing from the spirit and scope of the invention in its broadest form.

1. A system for using a mobile telephone to retrieve information about an article, comprising:
a camera, associated with said mobile telephone, that records an image of coded data associated with said article; and
a database, remote from said mobile telephone, that supplies information about said article to said mobile telephone based on a received, decoded form of said coded data derived from said image.

2. The system as recited in claim 1 wherein said coded data is received from said mobile telephone via a selected one of:
an infrared connection, and
a direct radio link.

3. The system as recited in claim 2 wherein said direct radio link conforms to a standard selected from the group consisting of:
Bluetooth,
WLAN, and
HomeRF/SWAP.

4. The system as recited in claim 1 wherein said coded data is decoded in said mobile telephone.

5. The system as recited in claim 1 wherein said mobile telephone contains software that defines a structure corresponding to said database.

6. The system as recited in claim 1 wherein said coded data is contained in a barcode.

7. The system as recited in claim 1 wherein said mobile telephone provides said information to a user a selected one of:
visually, and
acoustically.

8. The system as recited in claim 1 wherein said information comprises price information.

9. The system as recited in claim 8 wherein said database contains said price information in at least two different currencies.

10. The system as recited in claim 1 wherein a memory in said mobile telephone stores data pertaining to a plurality of articles and said image is a video sequence.

11. A method of using a mobile telephone to retrieve information about an article, comprising:
recording, with a camera associated with said mobile telephone, an image of coded data associated with said article; and
supplying, from a database remote from said mobile telephone, information about said article to said mobile telephone based on a received, decoded form of said coded data derived from said image.

12. The method as recited in claim 11 wherein said coded data is received from said mobile telephone via a selected one of:
an infrared connection, and
a direct radio link.

13. The method as recited in claim 12 wherein said direct radio link conforms to a standard selected from the group consisting of:
Bluetooth,
WLAN, and
HomeRF/SWAP.

14. The method as recited in claim 11 further comprising decoding said coded data in said mobile telephone.

15. The method as recited in claim 11 wherein said mobile telephone contains software that defines a structure corresponding to said database.

16. The method as recited in claim 11 wherein said coded data is contained in a barcode.

17. The method as recited in claim 11 further comprising providing, with said mobile telephone, said information to a user a selected one of:
visually, and
acoustically.

18. The method as recited in claim 11 wherein said information comprises price information.

19. The method as recited in claim 18 wherein said database contains said price information in at least two different currencies.

20. The method as recited in claim 11 further comprising storing, in a memory in said mobile telephone, data pertaining to a plurality of articles and said image is a video sequence.

21. A mobile telephone, comprising:
a camera;
software that receives an image associated with an article from said camera, decodes coded data contained in said image and queues said data for transmission to a database remote from said mobile telephone; and
a display that receives and displays information about said article from said database.
